(19) United States
(12) Patent Application Publication
(10) Pub. No.: US 2008/0124021 A1
(43) Pub. Date: May 29, 2008

(54) PHOTOELECTRONIC HYBRID BOARD AND CONNECTOR USING THE SAME

(76) Inventors: Yu-Dong BAE, Suwon-si (KR); Jeong-Seok Lee, Anyang-si (KR); Jun-Young Lee, Yongin-si (KR); Jeong-Hwan Song, Seoul (KR); Sung-Wook Kang, Seoul (KR)

Correspondence Address: CHA & REITER, LLC, 210 ROUTE 4 EAST STE 103, PARAMUS, NJ, 07652, US

(21) Appl. No.: 11/939,699

(22) Filed: Nov. 14, 2007

(30) Foreign Application Priority Data
Nov. 24, 2006 (KR) 2006-116906

(51) Int. Cl. G02B 6/12

(52) U.S. Cl. 385/14

(57) ABSTRACT

A photoelectronic hybrid board includes a circuit board having a circuit pattern layer and at least partially transparent to light, and a core laminated on a transparent portion of the circuit board and guiding light, which is coupled from outside, through an inside thereof. A connector includes a circuit board having a circuit pattern layer and at least partially transparent to light, a core laminated on a transparent portion of the circuit board and guiding light through an inside thereof, and at least one connection terminal formed at one end of the circuit board. Another connector includes the circuit board, a clad formed on a transparent portion of the circuit board, at least one core embedded in the clad and guiding light therethrough, and the at least one connection terminal.

### CLAIM OF PRIORITY

This application claims the benefit of an earlier patent application entitled “Photoelectronic Hybrid Board and Connector Using the Same,” filed in the Korean Intellectual Property Office on Nov. 24, 2006 and assigned Serial No. 2006-116906, the contents of which are hereby incorporated by reference.

### BACKGROUND OF THE INVENTION

1. Field of the Invention

The present invention relates to a circuit board, and more particularly to a photoelectronic hybrid board in which an optical waveguide and an electronic circuit board are integrated therein.

2. Description of the Related Art

Digital apparatuses have been evolved in the form of complex electronic appliances and now provides additional functions, such as a camera function and a music file playback function. At the same time, mobile communication terminals and digital apparatuses are required to be smaller and lighter so as to facilitate its portability. Modern mobile communication terminals, digital apparatuses and the like requires means for inputting/outputting high-capacity data, such as image data and sound data, at high speed.

The above mentioned data processing scheme may be implemented using a printed circuit board (PCB), but processing high-speed data only by an electric data transmission/reception method may cause a problem of electromagnetic interference (EMI).

In order to minimize the problem of EMI, there has been proposed a photoelectronic hybrid board in which an optical waveguide and an electronic circuit board are combined. However, the photoelectronic hybrid board has a drawback in that its application to a flexible printed circuit board and a slim-type mobile communication terminal is restricted because it has large thickness and lower flexibility.

### SUMMARY OF THE INVENTION

Accordingly, the present invention has been made to solve the above-mentioned problems occurring in the prior art and provides additional advantages, by providing a photoelectronic hybrid board, which can be applied to a flexible PCB and a slim-type mobile communication terminal, by minimizing the lowering of flexibility.

In accordance with an aspect of the present invention, a photoelectronic hybrid board includes: a circuit board having a circuit pattern layer and at least partially transparent to light; and a core laminated on a transparent portion of the circuit board and guiding light, which is coupled from outside, through an inside thereof.

In accordance with another aspect of the present invention, a connector includes: a circuit board having a circuit pattern layer and at least partially transparent to light; a core laminated on a transparent portion of the circuit board and guiding light, which is coupled from outside, through an inside thereof; and at least one connection terminal formed at one end of the circuit board.

In accordance with yet another aspect of the present invention, a connector includes: a circuit board having a circuit pattern layer and at least partially transparent to light; a clad formed on a transparent portion of the circuit board; at least one core formed in such a manner as to be embedded in the clad and guiding light, which is coupled from outside, through an inside thereof: and at least one connection terminal formed at one end of the circuit board.

### BRIEF DESCRIPTION OF THE DRAWINGS

The above features and advantages of the present invention will be more apparent from the following detailed description taken in conjunction with the accompanying drawings, in which:

FIG. 1 is a perspective view of a photoelectronic hybrid board according to a first embodiment of the invention;

FIG. 2 is a sectional view taken along line A-A′ in FIG. 1;

FIG. 3 is a perspective view of a connector according to a second embodiment of the invention;

FIG. 4a is a perspective view of a connector according to a third embodiment of the invention;

FIG. 4b is a sectional view taken along line B-B′ in FIG. 4a;

FIG. 5 is a perspective view of a connector according to a fourth embodiment of the invention; and

FIG. 6 is a perspective view of a connector according to a fifth embodiment of the invention;

### DETAILED DESCRIPTION OF THE INVENTION

Hereinafter, exemplary embodiments of the present invention will be described with reference to the accompanying drawings. For the purposes of clarity and simplicity, a detailed description of known functions and configurations incorporated herein will be omitted as it may make the subject matter of the present invention unclear.

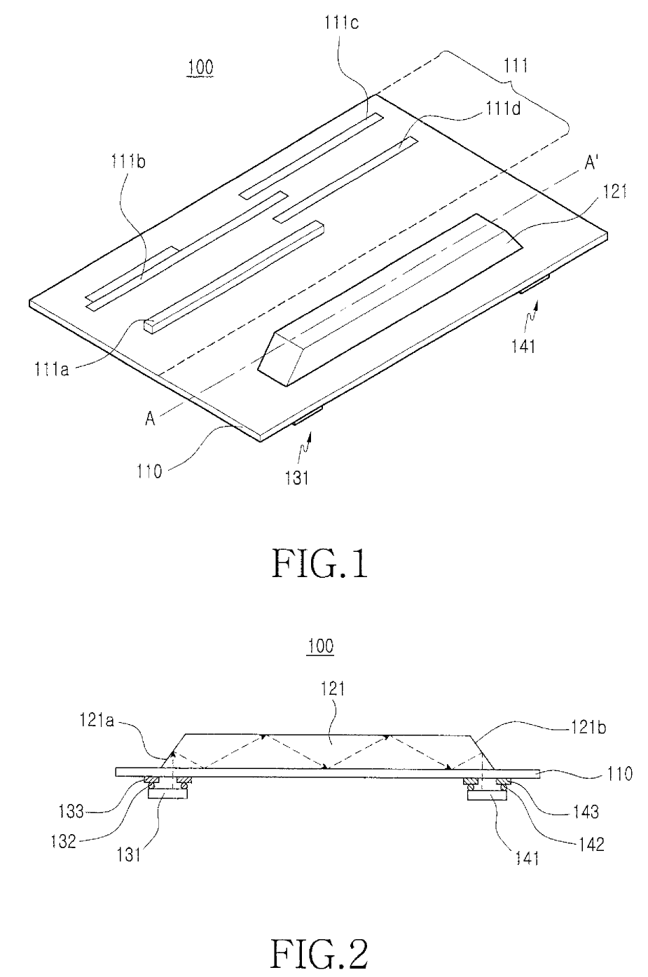

FIG. 1 illustrates a photoelectronic hybrid board according to a first embodiment of the present invention, and FIG. 2 illustrates a sectional view taken along line A-A′ in FIG. 1. Referring to FIGS. 1 and 2, the photoelectronic hybrid board 100 according to this embodiment includes a circuit board 110 having a circuit pattern layer 111 that is at least partially transparent to light, a core 121 guiding light coupled from outside through its inside, optical elements 131, 141 located at the bottom of the circuit board 110, bond pads 133, 143 interposed between the circuit board 110 and the optical elements 131, 141, and solders 132, 142 inserted between the bonding pads 133, 143 and the optical elements 131, 141.

The circuit pattern layer 111 is formed on the circuit board 110 excluding a portion transparent to light, and may be formed by laminating a Cu circuit layer, a Cu plating layer, and a cover layer on the circuit board 110 and etching them. The circuit pattern layer 111 may consist of a plurality of circuit patterns 111a, 111b, 111c, 111d.

The core 121 is formed on the transparent portion of the circuit board 110, on which the circuit pattern layer 111 is not formed. According to this embodiment, the core 121 is exposed to the air having a lower refractive index than the core, thereby satisfying a boundary condition for guiding light. In addition, the circuit board 110 contacted by the core 121 may be made of an insulating material having a lower refractive index than that of the core 121, such as polyimide. That is, the core 121 has a higher refractive index than that of the transparent portion where the core 121 makes contact with the circuit board 110.

Both end surfaces of the core 121, perpendicular to a longitudinal direction thereof, may be formed in such a manner as to be inclined at a predetermined angle with respect to the longitudinal direction, in particular, at 45° with respect to the longitudinal direction of the circuit board 110 or the core 121. Reflecting layers 121a, 121b are formed on both the inclined end surfaces of the core 121 respectively. One 121a of the reflecting layers reflects light, which is coupled from outside into the core 121, in the longitudinal direction of the core 121 whereas the other 121b may reflect light, guided into the core 121, in the direction of a corresponding optical element 141.

The optical elements 131, 141 are located at the bottom of the circuit board 110 in a position corresponding to the reflecting layers 121a, 121b, and may include a light source 131 for generating light and outputting the generated light toward the reflecting layer 121a, a light detector 141 for detecting light reflected from the reflecting layer 121b, etc. The optical elements 131, 141 are bonded to the bottom of the circuit board 110 by using the bond pads 133, 143, and bonded to the bond pads 133, 143 by the solders 132, 142.

Since the core 121 and the circuit pattern layer 111 share the circuit board 110, the present invention can be easily adopted in a slimmer portable terminal or electronic apparatus, and can provide a more flexible photoelectronic hybrid board since a further separate clad is not needed.

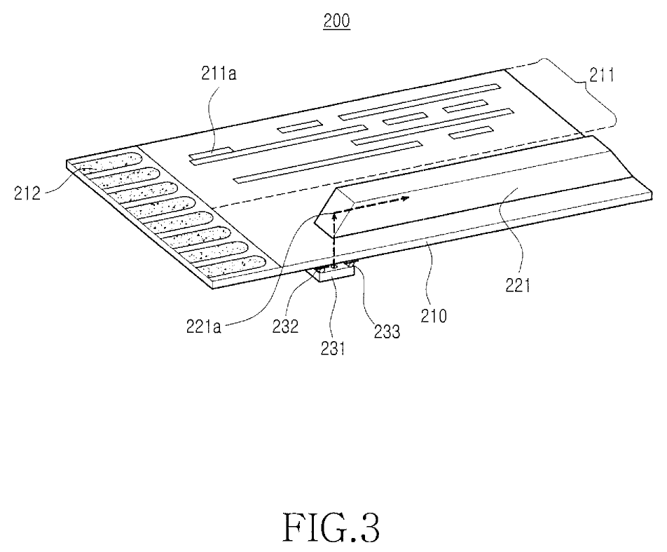

FIG. 3 illustrates a sectional view of a connector according to a second embodiment of the invention. To avoid redundancy, the following embodiments of the present invention, a repetitive description of the same constructions as those of the first embodiment will be omitted.

Referring to FIG. 3, the connector 200 further includes at least one connection terminal 212 added to the photoelectronic hybrid board as shown in FIG. 1. The connection terminal 212 can be formed at one end or both ends of the circuit board 210, and connected to another board, connector or other connection terminals.

The photoelectronic hybrid board includes a circuit board 210 having a circuit pattern layer 211 and is at least partially transparent to light, a core 221 located on a transparent portion of the circuit board 210 for guiding light through its inside, an optical element 232 located at the bottom of the circuit board 210, a bond pad 233 interposed between the circuit board 210 and the optical element 231, and a solder 232 inserted between the bond pad 233 and the optical element 23 1. The circuit pattern layer 211 may consist of at least one circuit pattern 211a.

Reflecting layers 221a are formed on both end surfaces of the core 221, which are formed in such a manner as to be inclined at a predetermined angle with respect to a light path. For example, one end surface of the core 221, on which the reflecting layer 221a is formed may be formed in such a manner as to be inclined at 45° with respect to a light path.

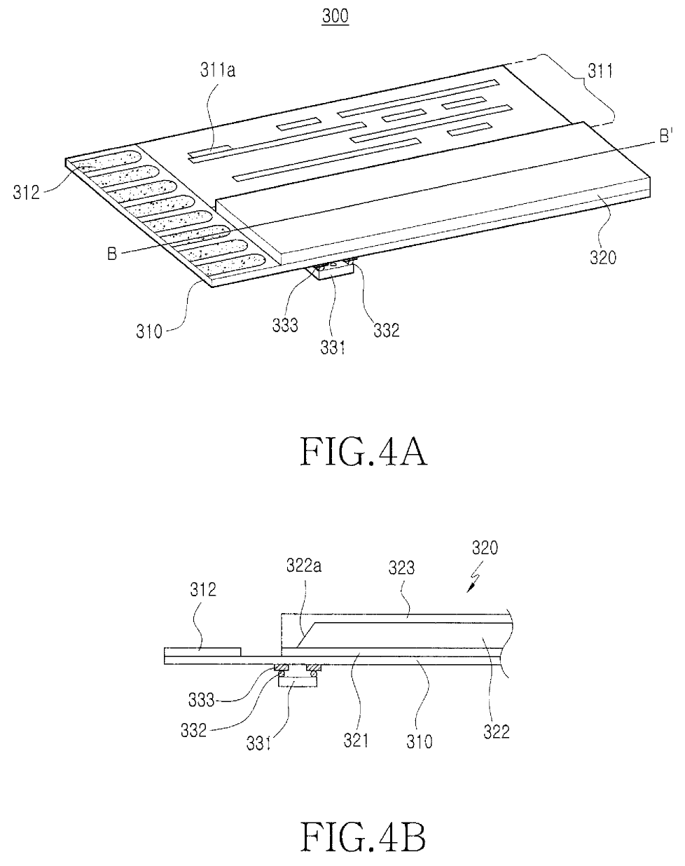

FIG. 4a illustrates a connector according to a third embodiment of the present invention, and FIG. 4b illustrates a sectional view taken along line B-B′ in FIG. 4a. Referring to FIGS. 4a and 4b, a connector 300 includes a circuit board 310 having a circuit pattern layer 311 and at least partially transparent to light, a waveguide 320 formed on a transparent portion of the circuit board, and at least one connection terminal 312 formed at one end of the circuit board 310.

The waveguide 320 is grown on the transparent portion of the circuit board 310, and includes clads 321, 323 and at least one core 322. The core 322 is formed in such a manner as to be embedded in the clads 321, 323 and guides light, which is coupled from outside, through its inside. The clads 321, 323 are made of a material having a lower refractive index than that of the core 322. That is, the core 322 and the clads 321, 323 can satisfy a boundary condition for guiding light, which is coupled into the core 322, by total reflection.

Reflecting layers 322a are formed on both end surfaces of the core 221, which are formed in such a manner as to be inclined at a predetermined angle with respect to a light path. For example, one end surface of the core 221, on which the reflecting layer 322a is formed, may be formed in such a manner as to be inclined at 45° with respect to a light path.

In addition, an optical element 331 may be seated at the bottom of the circuit board 310 in a position corresponding to the reflecting layer 322a. The optical element 331 may be bonded to the circuit board 310 by a bond pad 333 interposed between the circuit board 310 and the optical element 311 and by a solder 332 inserted between the bond pad 333 and the optical element 331.

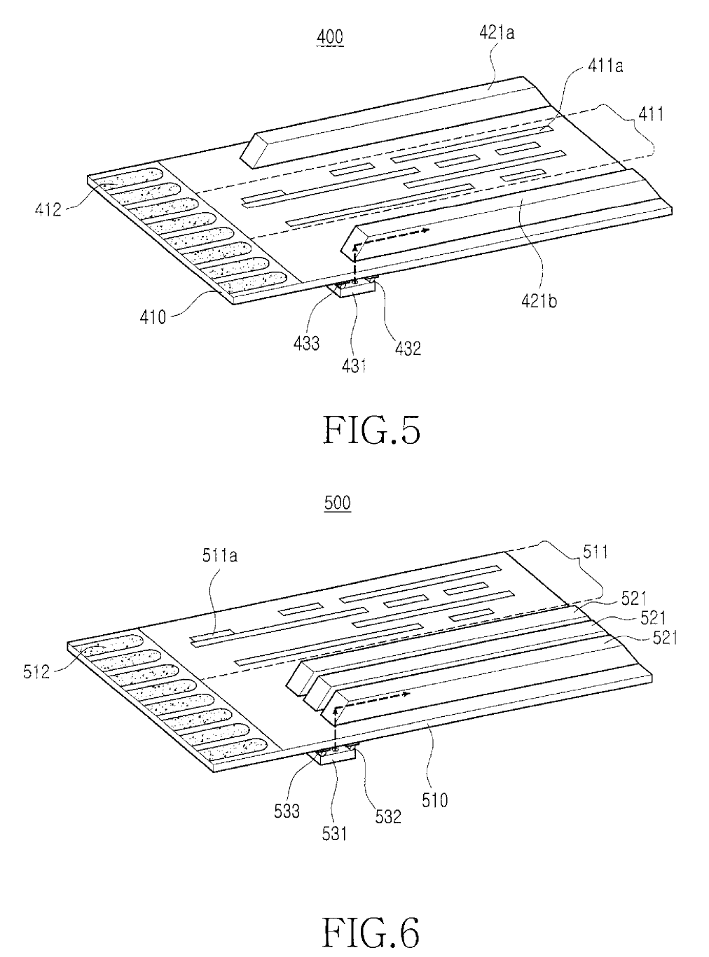

FIG. 5 illustrates a connector according to a fourth embodiment of the present invention, and FIG. 6 illustrates a connector according to a fifth embodiment of the present invention. The fourth and third embodiments shown in FIGS. 5 and 6 have the same construction as earlier embodiment, except that the fourth embodiment has a structure in which a circuit pattern layer is placed in the middle of a transparent circuit board and two cores are symmetrically disposed on right and left sides of the circuit pattern layer, and the fifth embodiment has a structure in which a plurality of cores are disposed on one side of a transparent circuit board.

Each of the connectors 400, 500 shown in FIGS. 5 and 6 includes a photoelectronic hybrid board as shown in FIG. 1 and further includes at least one connection terminal 412, 512 on the photoelectronic hybrid board. The connection terminals 412, 512 are formed at one end of the circuit boards 410, 510, and may be connected to another board, connector or other connection terminals.

The photoelectronic hybrid board includes a circuit board 410, 510 having a circuit pattern layers 411, 511 and is at least partially transparent to light, at least one core 421a, 421b, 521 laminated on a transparent portion of the circuit board 410, 510 and guiding outside light through its inside, an optical element 431, 531 located at the bottom of the circuit board 410, 510, a bond pad 433, 533 interposed between the circuit board 410, 510 and the optical element 431, 531, and a solder 432, 532 inserted between the bond pad 433, 533 and the optical element 431, 531. The circuit pattern layer 411, 511 may consist of at least one circuit pattern 411a, 511a.

Reflecting layers may be formed on both end surfaces of the core 421a, 421b, 521, which are formed are formed in such a manner as to be inclined at a predetermined angle with respect to a light path. The core 521 shown in FIG. 6 is deposited on the circuit board 510 in the form of a wide plate, and then its side surfaces are exposed to the air by grooves formed in a blade process. Since the air having a lower refractive index than that of the core 521 (normally, the air has a refractive index of 1) serves as a clad, the core 521 can satisfy a boundary condition for guiding light, which is coupled into the core 521, by total reflection.

As described above, the present invention can be easily applied to portable digital apparatuses having a slimmer structure because a core is formed parallel with circuit patterns on a circuit board on which a circuit pattern layer is formed.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A photoelectronic hybrid board comprising:
a circuit board having a circuit pattern layer and is at least partially transparent to light; and
a core laminated on a transparent portion of the circuit board and guiding outside light through an inside thereof.

2. The photoelectronic hybrid board as claimed in claim 1, further comprising reflecting layers formed on both end surfaces of the core, which are perpendicular to a longitudinal direction of the core and are formed in such a manner as to be inclined at a predetermined angle with respect to the longitudinal direction of the core.

3. The photoelectronic hybrid board as claimed in claim 2, wherein the predetermined angle is 45°.

4. The photoelectronic hybrid board as claimed in claim 2, further comprising:
optical elements, each of which is located at a bottom of the circuit board in a position corresponding to each reflecting layer;
bond pads interposed between the circuit board and the optical elements; and
solders inserted between the bond pads and the optical elements.

5. The photoelectronic hybrid board as claimed in claim 3, wherein one of the optical elements comprises a light source for generating light.

6. The photoelectronic hybrid board as claimed in claim 3, wherein one of the optical elements comprises a light detector for detecting light.

7. The photoelectronic hybrid board as claimed in claim 1, wherein the core has a higher refractive index than a refractive index of the transparent portion where the core makes contact with the circuit board.

8. The photoelectronic hybrid board as claimed in claim 1, wherein the circuit pattern layer is formed by laminating a Cu circuit layer and a Cu plating layer.

9. A connector comprising:
a circuit board having a circuit pattern layer and is at least partially transparent to light;
a core laminated on a transparent portion of the circuit board and guiding outside light through an inside thereof, and
at least one connection terminal formed at one end of the circuit board.

10. The connector as claimed in claim 9, further comprising reflecting layers formed on both end surfaces of the core, which are perpendicular to a longitudinal direction of the core and are formed in such a manner as to be inclined at a predetermined angle with respect to the longitudinal direction of the core.

11. The connector as claimed in claim 10, further comprising:
optical elements, each of which is located at a bottom of the circuit board in a position corresponding to each reflecting layer;
bond pads interposed between the circuit board and the optical elements; and
solders inserted between the bond pads and the optical elements.

12. The photoelectronic hybrid board as claimed in claim 9, wherein the circuit pattern layer is formed by laminating a Cu circuit layer and a Cu plating layer.

13. The photoelectronic hybrid board as claimed in claim 9, wherein the core has a higher refractive index than a refractive index of the transparent portion where the core makes contact with the circuit board.

14. A connector comprising:
a circuit board having a circuit pattern layer and is at least partially transparent to light;
a clad formed on a transparent portion of the circuit board;
at least one core formed in such a manner as to be embedded in the clad and guiding light, which is coupled from outside, through an inside thereof; and
at least one connection terminal formed at one end of the circuit board.

15. The photoelectronic hybrid board as claimed in claim 14, wherein the circuit pattern layer is formed by laminating a Cu circuit layer and a Cu plating layer.

16. The photoelectronic hybrid board as claimed in claim 15, wherein the core has a higher refractive index than a refractive index of the transparent portion where the core makes contact with the circuit board.
